(19) United States
(12) Patent Application Publication
(10) Pub. No.: US 2012/0178046 A1
(43) Pub. Date: Jul. 12, 2012

(54) Dental prosthesis

(76) Inventor: Maris J. Lans, Highland Park, IL (US)

(21) Appl. No.: 12/929,270

(22) Filed: Jan. 12, 2011

(51) Int. Cl. A61C 13/007

(52) U.S. Cl. 433/172

(57) ABSTRACT

A dental prosthesis is described which includes two separable halves with three rigid wires extending through the halves and protruding beyond them and providing a resin to anchor the prosthesis to adjacent teeth.

### RELATED APPLICATIONS

There are no related patent applications.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention is directed to an intracoronally supported dental prosthesis that can be formed in place during one sitting or visit to the dentist.

2. Description of the Prior Art

Dental prosthesis of the general type considered here are conventionally planned, constructed and installed over a period of time and requires two or more visits to the dentist's office. Initially the dentist will make measurements, and the pontic is then prepared by a dental lab pursuant to the dentist's specifications. When the dentist is satisfied with the configuration and color of the pontic, he or she will then install it by support means attached to the adjacent teeth. This is a satisfactory process and results in an excellent dental prosthesis, when time and circumstances are favorable. However, such a procedure takes considerable time and is costly. Sometimes, the circumstances for such a procedure are not favorable and time is limited. For instance, in remote areas or third world countries, the visiting dentist is going to see the patient only once or over an extended period of time if multiple visits are required. Circumstances do not permit multiple visits to the dentist and there are no dental labs conveniently nearby.

So far as applicant is aware, the most relevant prior art are applicant's own patents, U.S. Pat. No. 5,888,068 to Lans et al. issued Mar. 30, 1999 and U.S. Pat. No. 6,050,820 to Lans et al. issued Apr. 18, 2000. The '068 patent discloses an intracoronally supported dental pontic including opposing wings for anchoring the device into adjacent teeth. In use, parallel slots are drilled into the interior sides of the teeth adjacent a missing tooth. The slots are formed to correspond with the wings of the inventive device such that the prosthetic device is then inserted from behind and into the prepared space. The '820 patent discloses the improvement whereby the pontic further comprises a matrix folded to form a horizontal top portion and a vertical bottom portion, thereby increasing the structural rigidity of the device. As compared to the device of the '068 patent, the device of the '820 patent is able to withstand greater forces during, for example, mastication, and exhibits greater durability.

These teachings do not aid in the resolution of a number of practical difficulties that are resolved by the present invention.

### SUMMARY OF THE INVENTION

The present invention is directed towards a dental prosthesis' body formed of two halves separated by a seam. Three rigid wire members extend through bores formed through the body matrix, and have opposite ends which extend beyond the matrix. The two halves of the body can be moved away from one another so as to extend the width of the prosthesis to adjust to the width of the gap it is intended to fill. When the body of the prosthesis has been appropriately adjusted, the face of the prosthesis is applied to the matrix. When it is colored and continued to the dentist's satisfaction, it is then permanently installed, by the means of slots drilled in adjacent teeth, into which the protruding wire ends are fitted and secured by cured resin.

It is an object of the present invention to provide a dental prosthesis that can be formed and permanently installed by a dentist in the course of a single visit

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended Figures, in which:

FIG. 1 is front elevational view of the dental prosthesis;

FIG. 2 is the same view as FIG. 1, but with the two halves of the prosthesis in an expanded position;

FIG. 3 is a cross sectional view of the prosthesis matrix taken along dotted line 4 of FIG. 1;

FIG. 4 is the same view as FIG. 3, but with the pontic face applied; and

FIG. 5 is a rear elevational view of the prosthesis, mounted between adjacent teeth of a patient.

### DESCRIPTION OF THE INVENTION

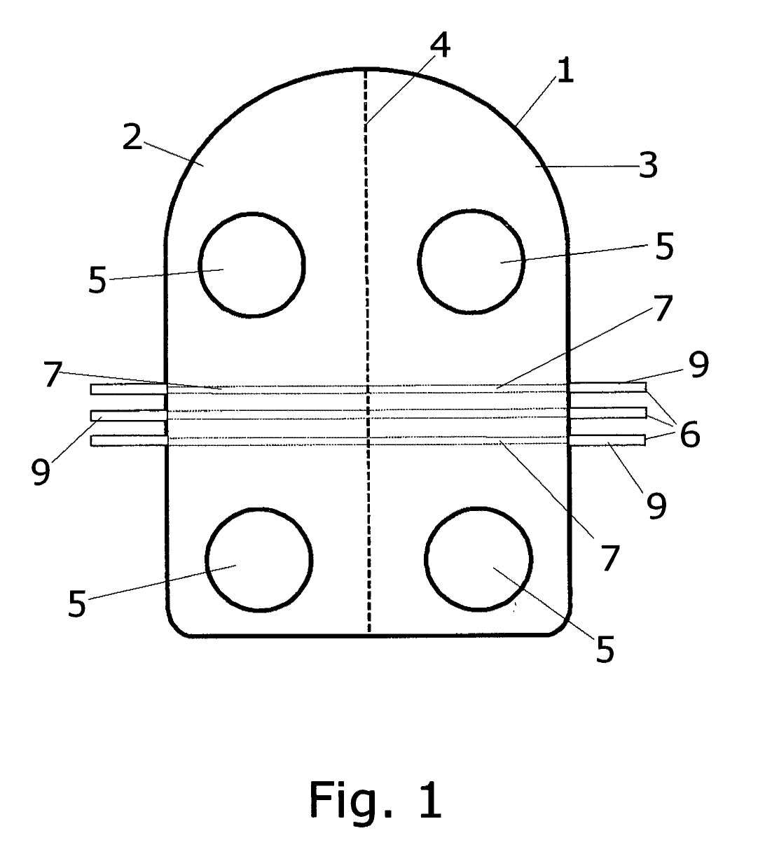

The best mode and preferred embodiment of the present invention is shown in FIGS. 1-5.

Directing attention to FIG. 1 of the drawings, a dental prosthesis body 1, is fabricated from micro-hybrid glass filled composite resin. The body can also be made of nano-filled composite resin, methacrylate based resin or other similar material by means of a stamping, cutting or injection molding process. The body 1 comprises a left half section 2 and a right half section 3. When the two sections 2 and 3 are placed adjacent each other, a seam 4 separates the left half section 2 from the right half section 3. Throughgoing apertures 5 are formed through the front face and rear face of the body horizontally through matrix 1. Wires 6 extend through the middle of body matrix 1 and opposite ends of wires 6, protrude beyond the opposite sides of the body matrix 1. The wires 6 extend through bores or channels 7 formed or cut in body 1, but are not adhered, so that the body 1 is moveable relative to wires 6.

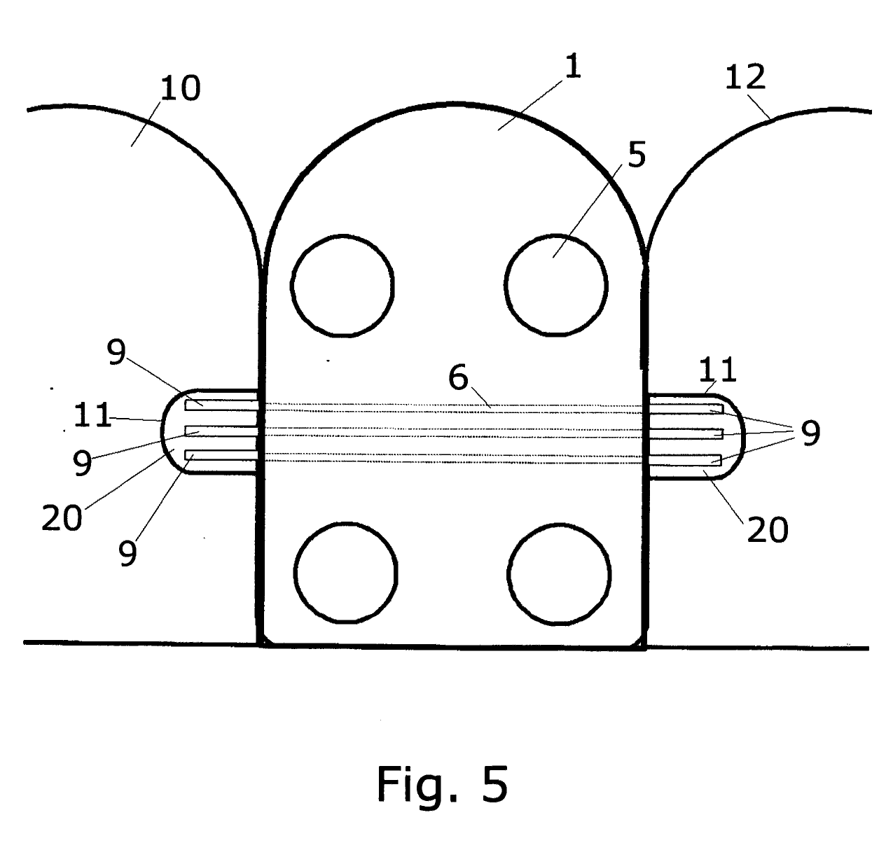

As shown in FIG. 5, the prosthesis is used to fill the gap created by a missing tooth. It is attached to and supported by the two adjacent teeth 10 and 12. Slots 11 are cut in the inward or lingual side of the adjacent teeth 10 and 12, by the dentist using a drill or other appropriate tool. The protruding ends 9 of wires 6 extend into the slots 11. After the prosthesis is completed and the dentist is completely satisfied with its shape and appearance, the slots 11, containing the ends 9, are filled with a resin 20, fixing the ends 9 of wires 6, securing the prosthesis in place.

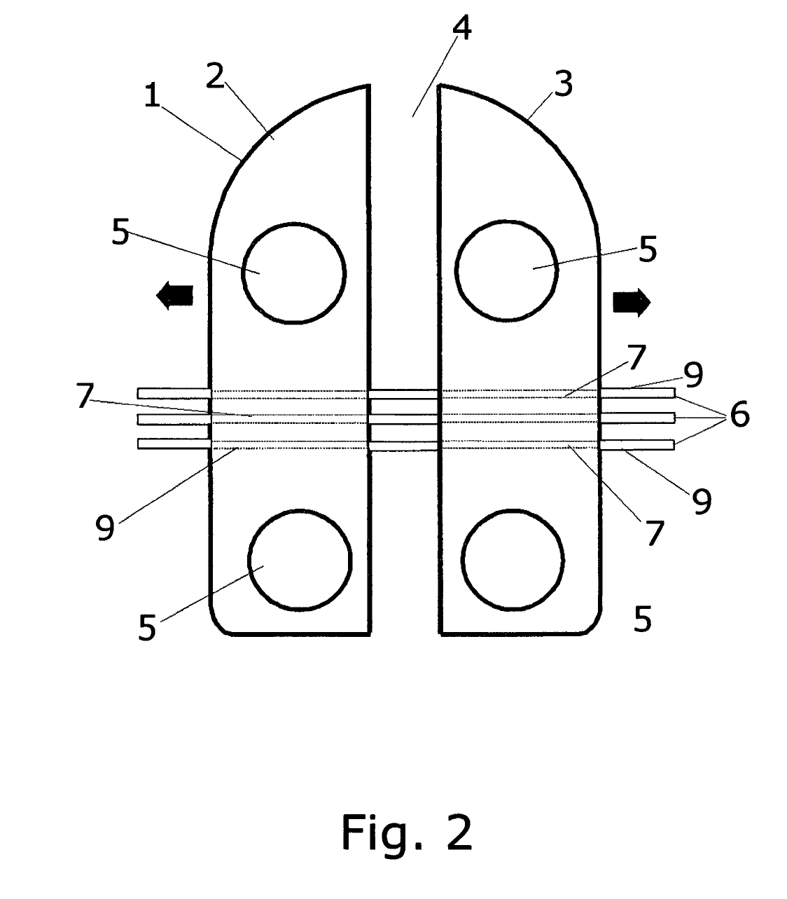

As illustrated in FIG. 2, the two body sections 2 and 3 which are preferably identical, can be moved apart from seam 4 along the wires 6 passing through the bores or channels 7 to accommodate such movement. This allows the dentist to adjust the width of the prosthesis body 1 to the exact width of the gap into which the prosthesis is to be installed.

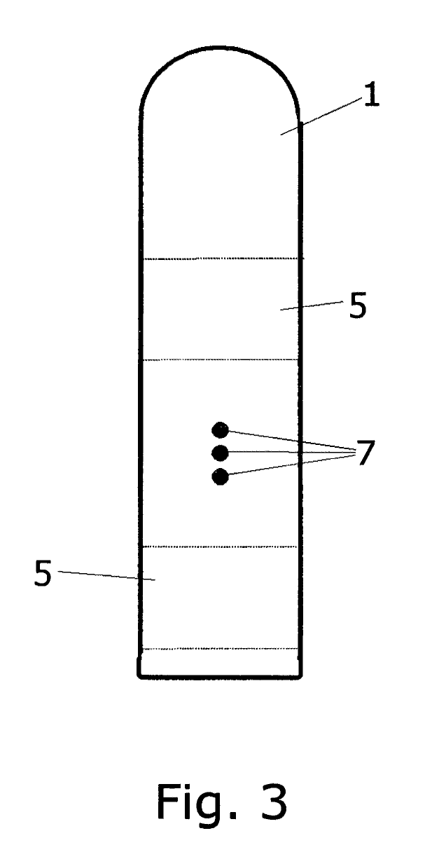

FIGS. 3 is a side cross sectional view of the matrix 1, showing the position of wire bores or channels 7 and pontic face apertures 5.

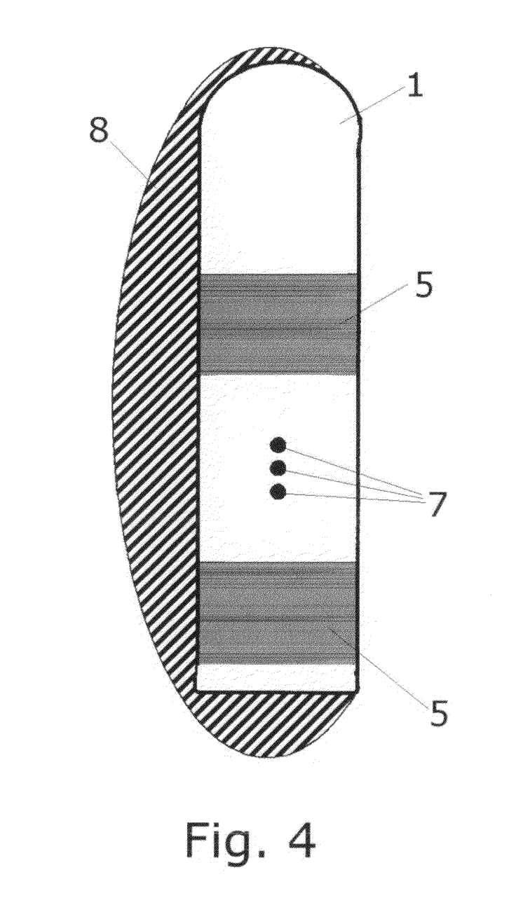

As shown in FIG. 4, after the body 1 has been adjusted to a proper fit, and the slots 11 formed and resin 20 has been applied, the pontic face 8 is applied to body 1 as shown in FIG. 4. Pontic face 8 is uncured resin which is packed, extending into the apertures 5 and onto body 1. The pontic face 8 extends over the top of body 1 and under the bottom of body 1. The pontic face 8 is contoured and tinted by the dentist to match the adjacent teeth. After the resin of pontic face 8 is hardened, the prosthesis is removed and polished on all sides. This is particularly important as to that surface of the prosthesis which extends into the gum socket, so it does not irritate the gum.

In the preferred embodiment illustrated, the wires are hardened stainless steel of 28 gauge thickness. However, any suitably narrow and rigid wire or strip could be used.

It will be further apparent to those skilled in the art that various modifications and variations can be made in the device and method of the present invention without departing from the spirit or scope of the invention.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A dental prosthesis comprising a body on which a pontic face portion can be adhered, at least one rigid member extending horizontally through a bore formed in said body, said at least one rigid member extending beyond opposing sides of said body allowing mounting of said dental prosthesis in adjacent slots formed on the lingual or palatal side of the mesial and distal teeth of a patient.

2. The dental prosthesis of claim 1, wherein said body comprises at least two separable sections divided by a vertical seam.

3. The dented prosthesis of claim 2, wherein said at least one rigid member extends through a bore formed in said at least two separable sections for sizing said body, said at least one rigid member being slidably movable relative to at least one of said at least two separable sections.

4. The dental prosthesis of claim 1, wherein said body includes means to facilitate adherence and support of said pontic face portion.

5. The dental prosthesis of claim 4, wherein said means to facilitate adherence and support of said pontic face portion comprises at least one or more apertures in said body.

6. The dental prosthesis of claim 3, wherein said at least one rigid member is a metal wire.

7. The dental prosthesis of claim 6, wherein said at least one rigid member is stainless steel.

8. The dental prosthesis of claim 1, wherein said body is a resin compound taken from a group consisting of a micro-hybrid glass filled with composite resin, nano-filled composite resin and methacrylate based resin.

9. (canceled)

10. A dental prosthesis comprising a body to which a pontic face portion can be adhered, said body comprising at least two separable sections divided by a vertical seam, at least one rigid member extending horizontally through a bore formed through said at least two separable sections of said body, each said at least one rigid member extending beyond opposing sides of said body and being adapted to mount in adjacent slots formed on the lingual or palatal side of the mesial and distal teeth of a patient; said at least two separable body sections being moveable along said at least one rigid member located within said bore.

11. The dental prosthesis of claim 10 wherein said at least two separable sections define at least one aperture extending from a front face to a rear face.

12. The dental prosthesis of claim 10 wherein said body is a resin compound taken from a group consisting of a micro-hybrid glass filled with composite resin, nano-filled composite resin and methacrylate based resin.

13. The dental prosthesis of claim 10, wherein said at least one rigid member is a metal wire.

14. A method for installing a dental prosthesis comprising:
forming slots in a patient's teeth on the lingual or palatal side of the mesial and distal teeth adjacent a dental prosthesis installation site, said dental prosthesis installation site accommodating a dental prosthesis comprising a body having at least two separable sections divided by a vertical seam, at least one rigid member extending horizontally through a respective bore formed through said body, each said at least one rigid member extending beyond opposing sides of said body and being adapted to mount said dental prosthesis adjacent said slots, said at least two separable body sections being moveable along said at least one rigid member located within said respective bore, said slots being suitable for receiving a protruding end of said at least one rigid member;
applying a pontic face portion to the front of said body; and
securing said at least one rigid member within said slots of said teeth.

15. The dental prosthesis of claim 2 wherein said at least two separable sections define at least one aperture extending from a front face to a rear face.
